(19) United States
(12) Patent Application Publication
(10) Pub. No.: US 2008/0320153 A1
(43) Pub. Date: Dec. 25, 2008

(54) Resource Management Device For a Communications Network With Inter-Node Connections Associated With Shared Resource Preemption Rights and Resource Access Priority Rights

(76) Inventors: Richard Douville, Longpont Sur Orge (FR); Martin Vigoureux, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 11/571,807

(22) PCT Filed: Jun. 14, 2005
(86) PCT No.: PCT/FR05/50443

§ 371 Date: Feb. 7, 2007

(30) Foreign Application Priority Data
Jul. 8, 2004 (FR) 0451470

(51) Int. Cl. G06F 15/16

(52) U.S. Cl. 709/229

(57) ABSTRACT

A device (D) is dedicated to the management of resources in a communications network comprising nodes (LER, LCR) connected together via connections. This device (D) comprises management means (MG) designed to define the connections and associate the connections with resources so that these connections can be setup when necessary. The management means (MG) are also required, according to a selected criterion, to associate each connection with either a first state in which it has a preemption right on selected resources shared at least partially with at least one other connection, although not authorized to use them, or a second state in which it is authorized to use the selected resources in order to setup this connection.

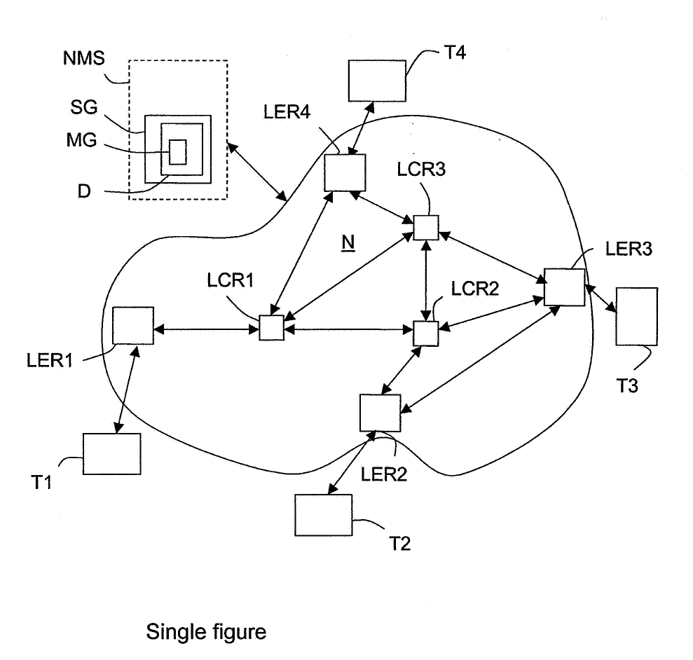

The invention relates to the field of communication networks with connection setup, and more particularly devices for the management of resources used by connections within such networks.

For the purposes of this description, “connection” means a data transmission circuit (physical or virtual) defined between two nodes in the network, possibly with intermediate nodes located between these two nodes. A connection may therefore be seen as a single logical link between two nodes (that may or may not be adjacent).

In connection-oriented networks supporting at least two switching layers, the so-called lower layer provides connectivity to the so-called upper layer through connections setup at its level. This connectivity enables the transporting of data from the upper layer. For example, in an IP network using (G)MPLS (“(Generalized) MultiProtocol Label Switching”) type protocols, information related to available connections is transmitted to the upper layer using a “TE” type extension link state routing protocol such as the OSPF-TE (“Open Shortest Path First-Traffic Engineering”) protocol.

Thus, when the upper layer would like data to be transported, it starts by analyzing information about the available connections so as to determine if one or a series of these available connections can carry said data, and if so, it transmits the data to the lower layer so that the lower layer can manage their transport.

As those skilled in the art are aware, in the above-mentioned existing networks, connections are provided in advance so as to anticipate the needs of the upper layer or to prevent congestion phenomena from occurring on the setup connections. These connections may be setup statically by estimating the present and future needs of clients using the network. The disadvantage of this approach is that network resources are permanently reserved in the data plane and the resources are used only occasionally in some cases. This causes the temporal wasting of resources. Another approach is to setup connections dynamically by estimating client needs at each moment and reassigning connections according to an estimate of needs. For example, the load on each setup connection is analyzed, and a new connection is setup when this load exceeds a selected threshold to avoid possible congestion. This is done by reserving network resources in the data plane for each provisioning connection, so that the connection can be setup in the lower layer. This approach enables the temporal reuse of resources. This means that the number of resources necessary for the network is less than the number necessary for a network operating with static connection setups.

The major disadvantage of this method of managing resources lies in the fact that when provisioning connections are created through the network, it is necessary to reserve a large number of resources for each of these connections, although the upper layer will not always use these resources under real operating conditions. The criterion for setting up provisioning connections is related to an estimate of client needs. This estimate may be improved, and has to be improved if a high service quality is to be guaranteed to clients so as to ensure that new connections are available to these clients at almost all times (the extreme solution being to provide the connections permanently and to return to a static model). In other words, the network is oversized in terms of the number of resources and is (effectively) underused, and is therefore more expensive than it should be.

In an attempt to improve the situation, it has been suggested that higher level load detection thresholds be used. However, an oscillation phenomenon may occur on the network in the presence of such thresholds. Indeed, the network is frequently obliged to very quickly release a previously setup provisioning connection, which obliges the lower layer to signal the unavailability of this previous connection to the higher layer. This can lead to data transmission errors affecting the upper layer when the frequency of the setups and releases becomes too high. Indeed, not all network nodes are informed instantaneously that the connection has disappeared and may attempt to use it.

It has also been suggested that provisioning connections should not be set up in advance. However, in this case, firstly the upper layer is not informed about the transport capacities of the lower layer and/or of the accessibilities through the lower layer, and secondly the service quality is poor because collisions may occur at client level and the time required for a new connection to be obtained may be more or less long.

There is no known fully satisfactory solution; the purpose of the invention is therefore to improve the situation.

To this end, it proposes a resource management device for a communications network comprising nodes connected together through connections, and comprising management means designed to define the connections and associate the connections with resources so that these connections can be setup when necessary.

This device is characterized by the fact that its management means are also responsible for associating with each connection, according to a selected criterion, either a first state in which it has a preemption right on selected resources shared at least partially with at least one other connection, although it is not authorized to use them, or a second state in which it is authorized to use the selected resources in order to setup this connection.

The device according to the invention may comprise additional characteristics that may be taken separately or combined, and particularly:
its management means may be required to order the lower layer to transmit the respective states of the connections to the upper layer, so that the upper layer knows the connections that are in their first state and may request that the lower layer use these connections for data transport, when necessary,
Its management means may be required to associate a priority level with the preemption right associated with a connection,
   when resources are shared by connections associated with a second state and with different preemption right priority levels, the connection with the highest priority level preferentially takes priority for the preemption of shared resources when it wishes to setup this connection,
   In the presence of resources shared by first and second connections with different preemption right first and second priority levels (the first level being lower than the second level) and when the first connection is in its second state while the second connection changes from its first state to its second state, the second connection is authorized to preempt the shared resources used by the first connection so as to setup this other connection, with the first setup connection being interrupted (or released),
   as a variant or as a complement, in the presence of resources shared by first and second connections with different preemption right first and second priority levels (the first level always being lower than the second level) and when the second connection is in its second state while the first connection changes from its first state to its second state, the first connection is not authorized to preempt the shared resources used by the second connection, in order to be setup, while the second setup connection remains in its second state. It therefore serves little purpose to setup or to keep connections associated with a first state and recorded on at least one resource used by a connection associated with a second state with a preemption right priority level higher than its own,
Its management means may be required to associate a setup probability level with connections associated with a first state, for example according to the load on connections that are simultaneously setup and used in the network,
   when resources are shared exclusively by connections associated with a first state with different setup probability levels, the connection with the highest setup probability level preferentially takes priority for the configuration of shared resources. If resources are reserved by a connection associated with a second state, then no other connection may change the configuration of these resources unless it has previously preempted this connection. This setup probability, whose usage is reserved exclusively for when resources are shared between connections associated with a first state, enables the reducing of the connection's setup time by changing it from its first state to its second state, assuming that part of the resources that it uses will have been pre-configured (reducing of the configuration time) before it is effectively reserved,
its management means may be required to change the state of a connection from the first state to the second state when the load on another setup connection exceeds a selected threshold, and/or if a specific request is received from a network user, the exceeding of the threshold and the demand each constituting a selected criterion,
if it becomes necessary to change the state of a connection from the first state to the second state, its management means may order the transmission of a change connection state message to the nodes through which this connection passes, to trigger a preemption of resources in order to set up the connection,
before associating a first state with a new connection, its management means may be required to order the preparation of a switching matrix between connections including this new connection, so that when the new connection state changes from the first state to the second state, the new connection can be setup almost immediately.

The invention is particularly, although non-exclusively, well suited to circuit switching networks with a (G)MPLS protocol suite IP control plane.

Other specific features and advantages of the invention will become clearer after reading the detailed description given below with reference to the appended single FIGURE that diagrammatically illustrates an example of a connection-oriented communications network equipped with a resource management device according to the invention. The appended FIGURE may be used not only to supplement the invention but may also contribute to its definition, where appropriate.

The purpose of the invention is to optimize the sizing of connection-oriented communications networks and to optimize the use of their resources.

To this end, it proposes one or more resource management devices D that will be installed in a connection-oriented communications network supporting at least two network protocol layers called the upper and lower layers.

In this description, the “upper layer” is a protocol layer responsible for processing data to be transported from one node of the network to another node of this network, and a “lower layer” is a protocol layer that will manage the transport of data from the upper layer via the connections (once they have been setup).

In the following, as an illustrative example it is considered that the network is a GMPLS (Generalized MultiProtocol Label Switching) protocol suite IP (Internet Protocol) network. However, the invention is not limited to this type of network. For example, it also relates to circuit switching networks (wavelengths, groups of wavelengths or SONET/SDH) for the lower layer.

Furthermore, in the following it is considered that the protocol used by the lower layer to transmit information about connections to the upper layer is a “TE” type extension link state routing protocol, such as the OSPF-TE (Open Shortest Path First-Traffic Engineering) protocol

The GMPLS IP network illustrated in the single FIGURE is part of the family of communication networks called “Label Switched Networks”. Such networks include network equipment (LERn, LCRm) defining nodes and each generally including a load distribution device (not shown).

The network equipment consists of Label Switched Routers (LSRs) (or nodes) coupled to each other. More precisely, these LSRs may be grouped into two categories, namely LERn (here n=1 to 4) edge routers (LERs or “Label Edge Routers”) and LCRm (here m=1 to 3) core routers (LCRs for “Label Core Routers”). LERs are notably responsible for setting up circuits (or “Label Switched Paths” (LSPs)), and LCRs are in particular responsible for switching data packets.

In this description, an LSP path (or virtual circuit) is a path between a source edge router LER and a destination edge router LER, defined by a sequence of links, each setup between two nodes. Furthermore, in this description, a “link” refers to a physical connection between two LSRs. Links are illustrated in the single FIGURE by two-directional arrows.

Note that an LSP path is usually calculated so as to optimize traffic transport between a source edge router LER and a destination edge router LER. In a GMPLS IP network, each edge router LER is designed, when it constitutes a source, so as to calculate the best path LSP for transferring the data that it receives towards the destination edge router LER, taking into account the service associated with the flows, the current topology of the network and the current loads on the links.

It is important to note that the destination edge router LER of a path LSP is the last router to which a labeled packet is transmitted within a zone (or domain), but not the destination address of said labeled packet.

Each edge router LER and each core router LCR has a switching matrix that switches the data flows received into at least one setup connection. In this description, a “setup connection” means a connection ready to transport data flows due to the configuration and specific activation (configuration) of the switching matrices of the various LER and LCR routers of which it is comprised.

A number of user or company terminals Ti (here i=1 to 4) are likely to be connected to at least some of the routers LERs so that data can be exchanged between them.

The GMPLS IP network also comprises a Network Management System (NMS) that transmits data to the routers LSR and extracts data from the latter to enable management of the network by an administrator (or manager).

The NMS usually comprises a management server SG in which a resource management device D according to the invention may be installed, which will be described below. In this case, the device D is of the centralized type so as to manage at least part of the network resources. However, a variant may be envisaged in which the resource management devices D may be distributed across the entire network. In this case, each router LSR has a management device D according to the invention dedicated to its own resources and not to all the network resources (or a part of them) as in the centralized case.

In the centralized case, the device D comprises a management module MG that defines the connections of at least part of the network and associates each firstly to selected resources, which may be shared at least partially with at least one other connection, and secondly with a representative state of a right or prohibition to preempt the resources associated with them.

More precisely, depending on the circumstances that depend on at least one selected criterion, each connection may either be associated with a first state in which it has a preemption right on the resources associated with it and that it shares at least partially with at least one other connection, although it is not authorized to use them, or associated with a second state in which it has this same preemption right but is authorized to use the selected resources for its setting up.

Thus, according to the invention, the connections are provided for in advance, but instead of associating specific resources with each connection, resources are shared between the connections and each connection is authorized or prohibited from using the resources associated with it and that it shares, so that it can be setup or released (or not setup) according to the needs at the time.

Preemption consists of reserving resources associated with a connection in what is usually called the data plane. Note that in an optical network, the reserving of resources consists of activating a cross-connection at the optical switch OXC.

The criterion used by the management module MG to decide on the state that must be associated with each connection may for example be a comparison with a setup connection load threshold. In this case, the management module MG is designed to analyze the load on each setup connection so as to compare it with the selected threshold. Then, if the analyzed load (of one or more setup connections) exceeds the selected threshold, the management module MG orders the activation of the node switching matrices belonging to a second connection that has not yet been setup so that future data flows will be switched from the first connection to the second connection. This prevents congestion on the first connection.

Of course, other criteria may be used, either instead of the criterion described above (threshold comparison), or simultaneously. Thus, one criterion may consist of the receiving of, or failure to receive, a specific request from a network user (client). In this case, when the management module MG receives a specific request, it determines the connection associated with a first state and that is the most appropriate for the client's needs, and then changes its state from the first state to the second state.

Activation of the switching matrices is accompanied by a change in the state of the second connection from the first state to the second state.

Furthermore, if at least one of the switching matrices to be activated has not been pre-configured to enable the switching of data flows to the second connection (and therefore its setting up locally), a configuration phase is performed before the activation phase during the reservation of resources for this connection.

When the state of the second connection has been modified and it may consequently preempt the resources associated with it, the lower protocol layer transmits a message to the upper protocol layer notifying it that it is keeping a new setup connection available for it. The upper protocol layer may then transmit the data that the new setup connection must transport to the lower protocol layer, if it considers this necessary.

Preferentially, the management module MG is also required to associate a priority level with the preemption right associated with a connection (and preferably with each connection). This has the effect of giving some connections a resource use priority.

For example, if resources are shared by connections that have different priority levels, the network may be configured such that the connection with the highest priority level takes priority for preemption of the resources that it shares with one or several other connections every time that it wishes to be setup. In other words, if two connections sharing resources must be setup at approximately the same time, only the connection with the highest priority level may use the resources associated with it and therefore be setup. Similarly, if a first connection that wishes to be setup is associated with a preemption right priority level higher than that of a second previously setup connection, then this first connection preempts the resources used by this second connection and the second connection is interrupted (or released).

It is important to remember that a first connection may only preempt the resources of a second setup connection if this first connection is in the second state or changes from a first state to a second state.

Furthermore, if resources are shared by a first connection with a first preemption right priority level and associated with a second state, and by a second connection with a second priority level higher than the first level and associated with a state changing from the first state to the second state, then the network may be configured such that the second connection is authorized to preempt the shared resources that are used by the first setup connection, so as to be setup instead of the first connection.

In other words, if a setup connection (and consequently a connection associated with a second state) is associated with a low preemption right priority level, another connection with which it shares resources may release it so that it may be setup instead, if its priority level is higher than its own.

In addition, if resources are shared by a first connection with a first preemption right priority level and associated with a state changing from the first state to the second state, and by a second connection with a second priority level higher than the first level and associated with a second state, the network may then be configured such that the first connection is not authorized to preempt the shared resources that are used by the second setup connection, so as to be setup instead of the second connection, while the second connection remains in its second state. This is why when connection provisioning is required, it is inappropriate to setup a first connection associated with a first state and recorded on at least one resource reserved by a second connection associated with a second state with a preemption right priority level higher than its own. On the other hand, this operation may be useful for network connection reconfiguration.

In other words, if a setup connection (a connection therefore associated with a second state) is associated with a high preemption right priority level, another connection, with which it shares resources and newly associated with a second state, cannot release it so as to be setup instead, unless the setup connection changes to the first state.

It is important to note that preemption right priority levels are not necessarily permanently associated with connections. For example, it will be possible for the management module MG to be designed so as to modify the priority level associated with one or more connections depending on the needs at the time or for a selected duration.

The management module MG may also be required to associate a setup probability level that may for example depend on the load on connections setup in the network, with at least some of the connections.

For example, it is assumed that a single connection is setup through the network to transport data between terminals T1 and T4. If this single connection is saturated (and therefore if it has a high load), the network is more likely to setup a new connection between terminals T1 and T4 than if this connection was only slightly busy (and therefore had a low load). The same probabilistic reasoning may be applied if there are several network connections. Thus, between two connections, for example defined between terminals T1 and T4 and between terminals T1 and T3, one of the two connections may have a load higher than the load on the other connection. If it is required to setup a connection associated with a first state for each of these connections as a provisioning connection, then a setup probability reflecting the load level of the connections that they are to replace may be associated with each of these provisioning connections. Thus, if these two provisioning connections share at least one common resource not reserved by a third connection associated with a second state, the connection with the highest setup probability may configure the resource(s) concerned.

Finally, the management module MG may be required to order the lower protocol layer to transmit a change of state message to each node through which this connection passes, designed to trigger the preemption of resources so that it can be setup, when it decides to change the state of a connection from the first state to the second state. This is particularly advantageous because in a conventional network, the reservation of resources at the nodes of a connection requires a first pass from the source node to the destination node to ask each node if it has available resources, then a second pass from the destination node to the source node to effectively reserve the resources requested during the first pass at each node.

The management device D according to the invention, and particularly its management module MG, may take the form of electronic circuits, software modules (or computer modules) or a combination of circuits and software.

The invention is not limited to the embodiments of the resource management device described above solely as an example, but it also encompasses all the variants that may be imagined by those skilled in the art within the framework of the claims given below.

Thus, in the above, an example embodiment of the invention has been described in which the management device was centralized so as to manage all or some of the network resources. However, the resources might also be managed in a distributed way over the entire network. In this case, each node (or router) has a management device according to the invention dedicated to its own resources.

1. Resource management device (D) for a communications network comprising nodes (LER, LCR) connected together via connections, said device comprising management means (MG) designed to define said connections and associate them with resources such that said connections may be setup when necessary, characterized by the fact that said management means (MG) are also designed to associate each connection, according to a selected criterion, with either a first state in which said connection has a preemption right on selected resources shared at least partially with at least one other connection, although not authorized to use them, and a second state in which said connection is authorized to use said selected resources in order to setup said connection.

2. Device set forth in claim 1, characterized by the fact that said management means (MG) are designed, before associating a first state with a new connection, to order the preparation of a switching matrix between connections including said new connection, so that when said new connection changes state from the first state to the second state, said new connection may be setup almost immediately.

3. Device set forth in claim 1, characterized by the fact that said management means (MG) are designed to order the transmission of the corresponding connection states to a so-called upper network protocol layer, by a so-called lower network protocol layer managing the transport of data originating from said upper layer through said connections once these connections have been setup, such that said upper layer knows which connections are in their first state and may ask said lower layer to use these connections for data transport, when necessary.

4. Device set forth claim 1, characterized by the fact that said management means (MG) are designed to associate a priority level with the preemption right associated with a connection.

5. Device set forth in claim 4, characterized by the fact that in the case of resources shared by connections with priority levels associated with a second state and with different preemption right priority levels, the connection with the highest priority level takes priority for the preemption of said shared resources in order to setup said connection.

6. Device set forth in claim 5, characterized by the fact that in the presence of resources shared by first and second connections with different first and second preemption right priority levels, said first level being lower than said second level, and when said first connection is associated with a second state while the second connection changes from the first state to the second state, said second connection is authorized to preempt said shared resources used by said first connection so as to setup said connection, said first setup connection then being interrupted.

7. Device set forth in claim 5, characterized by the fact that in the presence of resources shared by first and second connections with different first and second preemption right priority levels, said first level being lower than said second level, and if said second connection is associated with a second state while the first connection changes from the first state to the second state, said first connection is not authorized to preempt said shared resources used by said second connection in order to setup said connection, as long as said second setup connection remains associated with a second state.

8. Device set forth in claim 1, characterized by the fact that said management means (MG) are designed to associate a setup probability level with at least some of said connections associated with a first state.

9. Device set forth in claim 8, characterized by the fact that said setup probability level depends on the load on the connections setup and used in said network.

10. Device set forth in claim 1, characterized by the fact that said management means (MG) are designed to change the state associated with a connection from the first state to the second state when the load of another setup connection exceeds a selected threshold, the exceeding of the threshold constituting said selected criterion.

11. Device set forth in claim 1, characterized by the fact that said management means (MG) are required to change the state associated with a connection from the first state to the second state on the receiving of a request from a user, said demand constituting said selected criterion.

12. Device set forth in claim 1, characterized by the fact that said management means (MG) are designed to order the transmission of a change of connection state message to the nodes (LER, LCR) through which this connection passes, if it becomes necessary to change the state of a connection from the first state to the second state, to trigger the preemption of resources in order to set up said connection.

13. Router (LER, LCR) for a connection-oriented communications network, characterized by the fact that it comprises a management device (D) according to one of the above claims, dedicated to the management of its own resources.

14. Management server (SG) for a communications network comprising nodes (LER, LCR) connected together via connections, characterized by the fact that it comprises a management device (D) according to claim 1, dedicated to the management of at least part of the resources of said network.

15. Use of the resource management device (D) according to claim 1 in (G)MPLS protocol suite IP networks.

16. Use of the resource management device (D) according to claim 1 in circuit switching networks.
